(19) United States
(12) Patent Application Publication
(10) Pub. No.: US 2026/0273499 A1
(43) Pub. Date: Sep. 17, 2026

(54) COUNTER-FLOW ELECTRIC STEAM-CRACKING FURNACE & METHODS

(71) Applicant: SABIC GLOBAL TECHNOLOGIES B.V.., Bergen op Zoom (NL)

(72) Inventor: Michael Edward HUCKMAN, Sugar Land, TX (US)

(73) Assignee: SABIC GLOBAL TECHNOLOGIES B.V.., Bergen op Zoom (NL)

(21) Appl. No.: 19/167,966

(22) PCT Filed: Mar. 19, 2024
(86) PCT No.: PCT/EP2024/057328

§ 371 Date: Sep. 23, 2025

(30) Foreign Application Priority Data
Mar. 24, 2023 (EP) 23164113.5

(51) Int. Cl. B01J 19/24; B01J 19/00; C10G 9/36

(52) U.S. Cl. CPC B01J 19/2425; B01J 19/0013; C10G 9/36; B01J 2219/00135; C10G 2300/1037; C10G 2300/1092

(57) ABSTRACT

Steam cracking systems are disclosed and can include: a quench unit having a quench unit inlet; and a radiative electric furnace having an fluid inlet and a fluid outlet in fluid communication with the quench unit inlet. The furnace can include: a housing defining a radiant heating chamber having a length, a width, and a height; one or more first electric heating elements disposed on a first side of the radiant heating chamber; one or more second electric heating elements disposed on a second side of the radiant heating chamber and spaced apart from the first electric heating element(s); a plurality of first tubes disposed between the first and second electric heating elements, and extending at least a majority of the length of the radiant heating chamber; and a plurality of second tubes disposed between the first and second electric heating elements.

### FIELD OF DISCLOSURE

The present disclosure is generally related to processes for producing chemicals and, more particularly but not by way of limitation, to a radiative electric furnace for steam cracking, and methods of steam cracking using such a radiative electric furnace.

### BACKGROUND

Chemical synthesis plants are utilized to provide a variety of chemicals. Often, a dedicated fuel is burned or combusted to provide heat of reaction for chemical synthesis, energy to heat one or more process streams, energy to vaporize liquids (e.g., boil water used as a diluent), energy to do work (e.g., drive a compressor or pump), or energy for other process operations throughout the chemical synthesis plant. Such burning or combustion of fuels results in the production of flue gases that contain CO₂, which can be harmful to the environment, and also results in a loss of energy efficiency of the process. Likewise, steam is often conventionally utilized as a plant-wide heat and/or energy transfer fluid within chemical synthesis plants. The steam utilized for the heat and/or energy transfer is often produced via the combustion of a fuel, resulting in the production of additional flue gas and further energy efficiency losses during the chemical synthesis.

However, the electrification of certain components in chemical synthesis plants presents additional issues and challenges. For example, in steam cracking processes, electric furnaces pyrolysis reactors may present issues or may be subject to considerations that are different than and/or not necessarily present in combustion-driven furnace pyrolysis reactors.

### SUMMARY

The present disclosure includes steam cracking systems, and methods of heating fluids in such systems with radiative electric cracking furnaces, that reduce local temperature peaks and temperature gradients in electric heating elements of a radiative electric cracking furnace, for example, to extend the useful life of the electric heating elements. More particularly, the present cracking furnaces include tubes for carrying feedstock and steam to be heated between the electric heating elements and, by alternating the flow direction within such tubes, local maximum and minimum tube temperatures are distributed throughout the interior of the heater, thereby taking advantage of the exchange of thermal radiation between relatively hotter and cooler surfaces to reduce the local temperature peaks otherwise experienced by heating elements and increasing useful life of the heating elements.

Some configurations of the present steam cracking systems comprise: a quench unit having a quench unit inlet; and radiative electric furnace having a fluid inlet and a fluid outlet in fluid communication with the quench unit inlet. Some such furnaces comprise: a housing defining a radiant heating chamber having a length, a width, and a height; one or more first electric heating elements disposed on a first side of the radiant heating chamber; one or more second electric heating elements disposed on a second side of the radiant heating chamber and spaced apart from the first electric heating element(s); a plurality of first tubes disposed between the first and second electric heating elements, and extending at least a majority of the length of the radiant heating chamber; and a plurality of second tubes disposed between the first and second electric heating elements, and extending at least a majority of the length of the radiant heating chamber; where the first tubes are in fluid communication with the fluid inlet and configured to carry a fluid in a first direction from a first end (or upper portion) of the radiant heating chamber toward a second end (or lower portion) of the radiant heating chamber; and where the second tubes are in fluid communication with the fluid inlet and configured to carry a fluid in a second direction from the second end (or lower portion) of the radiant heating chamber toward the first end (or upper portion) of the radiant heating chamber.

In some configurations of the present steam cracking systems, the second direction is parallel to the first direction.

In some configurations of the present steam cracking systems, at least one of the second tubes of the furnace is disposed one of (a)-(c): (a) between two of the first tubes; (b) between one of the first tubes and one of the first and second electric heating elements; or (c) both (a) and (b).

In some configurations, from 35% to 65%, or from 40% to 60% or from 45% to 55% of a total number of tubes disposed between the first and second electric heating elements (which is equal to a total number of first tubes plus a total number of second tubes) are first tubes. In still other configurations, each of the second tubes is adjacent to at least one of the first tubes. Accordingly, in operation, the process fluid flowing through the second tube flows counter-currently to the process fluid flowing through the adjacent first tube.

In some configurations of the present steam cracking systems, the first and second tubes are arranged in two rows of tubes, a first one of the two rows is disposed closer to the first electric heating element(s) than to the second electric heating element(s), and a second one of the two rows is disposed between the first row and the second electric heating element(s). In some such configurations, the first row comprises all of the first tubes, and the second row comprises all of the second tubes. In other such configurations, the first and second rows each comprise alternating first and second tubes. In some further configurations of the radiative electric furnace the first and second tubes are arranged in one row. In still other configurations, the first and second process tubes are arranged in n rows, where n is an integer of at least 3 with the proviso that at least one row consists of first tubes and at least one row consists of second tubes and is adjacent to the row of consisting of first process tubes.

In some configurations of the present steam cracking systems, the first and second electric heating elements are configured to reach a maximum temperature in excess of 1050° C.

In some configurations of the present steam cracking systems, the first and second tubes are also in fluid communication with the fluid outlet.

Some configurations of the present steam cracking systems further comprise a first inlet manifold between the fluid inlet and the first tubes, and a second inlet manifold between the fluid inlet and the second tubes.

In some implementations of the present methods of steam cracking, the method comprises: directing a fluid into a fluid inlet of a furnace and through a plurality of tubes between first and second electric heating elements disposed on opposing sides of a radiant heating chamber of the furnace to heat the fluid to a reaction temperature and begin a cracking reaction, the tubes extending along a length of the heating chamber and in fluid communication with a fluid outlet of the furnace, the fluid comprising a hydrocarbon feedstock and steam; and directing the fluid from the fluid outlet to an inlet of a quench unit to reduce the temperature of the fluid to below the reaction temperature and slow or stop the cracking reaction; where the plurality of tubes comprises a plurality of first tubes and a plurality of second tubes. In some such implementations, directing the fluid into the plurality of tubes comprises simultaneously: (1) directing a first portion of the fluid into the first tubes in a first direction extending from a first end (or upper portion) of the heating chamber toward a second end (or lower portion) of the heating chamber; and (2) directing a second portion of the fluid in a second direction into the second tubes in a second direction extending from the second end (or lower portion) of the heating chamber toward the first end (or upper portion) of the heating chamber.

In some implementations, from 35% to 65%, or from 40% to 60% or from 45% to 55% of a total number of tubes are first tubes (where the total number of tubes is equal to a total number of first tubes plus a total number of second tubes). In still other implementations, each of the second tubes positioned within the radiant heating chamber is adjacent to at least one of the first tubes. Accordingly, in some implementations, the fluid flowing through each of the second process flows counter-currently to the fluid flowing through at least one adjacent first tube.

In some implementations of the present methods of steam cracking, the hydrocarbon feedstock comprises at least one component selected from the list of components consisting of: naphtha, liquefied petroleum gas (LPG), and ethane.

In some implementations of the present methods of steam cracking, at least one of the second tubes of the furnace is disposed: between two of the first tubes; and/or between one of the first tubes and one of the first and second electric heating elements. In still other implementations, each of the second tubes of the furnace is adjacent to at least one of the first tubes. Accordingly, in some implementations, the fluid flowing through each of the second tubes flows counter-currently to the fluid flowing through at least one adjacent first tube.

In some implementations of the present methods of steam cracking, the first and second tubes are arranged in at least two rows of tubes, a first row of the at least two rows is disposed closer to the first electric heating element(s) than to the second electric heating element(s), and a second row of the at least two rows is disposed between the first row and the second electric heating element(s). In some such implementations, the first row comprises all of the first process tubes, and the second row comprises all of the second process tubes. In other implementations, the first and second rows each comprises alternating first and second process tubes. In some further implementation of the present methods the first and second tubes are arranged in a single row where at least one second tube is disposed: between two of the first tubes; and/or between one of the first tubes and one of the first and second electric heating elements.

In some implementations of the present methods of steam cracking, the heating elements exhibit a maximum temperature (T_{MAX}) and an average temperature (T_{AVE}); and where, as the fluid flows through the plurality of tubes, the difference between T_{MAX} and T_{AVE} (T_{MAX}−T_{AVE}) is less than one percent (1%) of T_{MAX}.

In some implementations of the present methods of steam cracking, the first and second electric heating elements reach a maximum temperature in excess of 1050° C. while the fluid flows through the plurality of tubes.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any embodiment of the present apparatuses, kits, and methods, the term “substantially” may be substituted with “within [a percentage] of” what is specified, where the percentage includes 0.1, 1, 5, and/or 10 percent.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, an apparatus or kit that “comprises,” “has,” “includes” or “contains” one or more elements possesses those one or more elements, but is not limited to possessing only those elements. Likewise, a method that “comprises,” “has,” “includes” or “contains” one or more steps possesses those one or more steps, but is not limited to possessing only those one or more steps.

The terms “upper portion” and “lower portion” refer to the portion of the chamber closer to the top and bottom of the chamber, respectively.

Further, an apparatus, device or system that is configured in a certain way is configured in at least that way, but it can also be configured in other ways than those specifically described.

Any embodiment of any of the present apparatuses and methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

Details associated with the embodiments described above and others are presented below.

Some details associated with the aspects of the present disclosure are described above, and others are described below. Other implementations, advantages, and features of the present disclosure will become apparent after review of the entire application, including the Brief Description of the Drawings, Detailed Description, and the Claims.

### BRIEF DESCRIPTION OF THE DRAWINGS

The following drawings illustrate by way of example and not limitation. For the sake of brevity and clarity, every feature of a given structure is not always labeled in every figure in which that structure appears. Identical labels or reference numbers do not necessarily indicate an identical structure. Rather, the same reference number may be used to indicate a similar feature or a feature with similar functionality, as may non-identical reference numbers. Dimensioned figures are drawn to scale (unless otherwise noted), meaning the sizes of the depicted elements are accurate relative to each other for at least the embodiment depicted in the figures.

FIG. 1 depicts block flow diagram of a generalized steam cracking plant or process.

FIG. 2 depicts a block flow diagram of the pyrolysis reaction section of the plant or process of FIG. 1.

FIGS. 3A and 3B, respectively, depict a conceptual block diagram of a first example of a unidirectional-flow electric furnace for use in the pyrolysis reaction section of FIG. 2, and a cutaway perspective view of the upper and lower walls and fluid tubes of the electric furnace of FIG. 3A.

FIGS. 4A and 4B, respectively, depict a conceptual block diagram of a first example of the present counter-flow electric furnaces for use in the pyrolysis reaction section of FIG. 2, and a cutaway perspective view of the upper and lower walls and fluid tubes of the electric furnace of FIG. 4A.

FIGS. 5A and 5B, respectively, depict a perspective view of fluid tubes of a second example of a unidirectional-flow electric furnace for use in the pyrolysis reaction section of FIG. 2, and a chart of temperature profile of the fluid tubes of FIG. 5A.

FIGS. 6A and 6B, respectively, depict a perspective view of fluid tubes of a second example of the present counter-flow electric furnaces for use in the pyrolysis reaction section of FIG. 2, and a chart of temperature profile of the fluid tubes of FIG. 6A.

FIGS. 7A and 7B depict cutaway perspective views of third and fourth examples of the present counter-flow electric furnaces for the pyrolysis section of FIG. 2.

### DETAILED DESCRIPTION

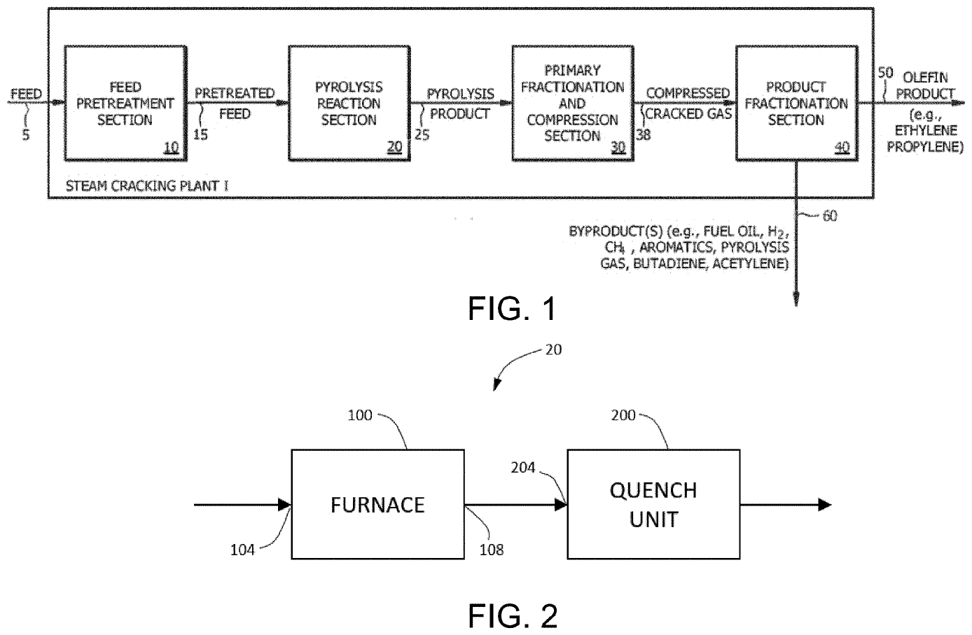

Referring now to the drawings, and more particularly to FIG. 1, shown there is a block flow diagram of an example of a generalized steam cracking plant or process, which includes one or more of the following process sections for converting a feed stream 5 into a desired olefin product stream 50: a feed pretreatment section 10, a pyrolysis reaction section 20, a primary fractionation and compression section 30, a product fractionation (separation) and compression section 40, or a combination thereof. Such sections will be described briefly in the next few paragraphs, and in more detail hereinbelow.

Feed pretreatment section 10 can be configured to adjust the pressure of a feed 5, possibly remove undesirable components (e.g., carbon dioxide (CO₂), mercury, water) from a feed, combine an incoming feed with a stored feed to minimize variations in the feed to the pyrolysis reaction section 20, and/or preheat the feed 5, to provide a pretreated feed stream 15.

Pyrolysis reaction section 20 can comprise at least one steam cracker or ‘pyrolysis’ furnace configured to crack hydrocarbons in the presence of steam to produce a cracked gas stream and a transfer line exchanger (TLE) or other heat transfer device to quench (and optionally harvest heat from) the cracked gas stream to provide a cooled cracked stream 25. Conventionally, the furnaces of a steam cracking plant create a high temperature environment by the combustion of fuels such as methane and hydrogen, which produces carbon dioxide emissions from a conventional steam cracking plant/process. However, in the present embodiments, the furnace is instead a radiative electric furnace in which electric heating elements provide heat or thermal energy in a heating chamber to tubes through which the feed stream flows.

The primary fractionation and compression section 30 can be configured to provide further heat recovery from and quenching of the cooled cracked gas stream 25, remove one or more components (e.g., fuel oil, hydrogen sulfide, carbon dioxide, water, or a combination thereof) from the cracked gas stream 25, and/or compress the cracked gas stream 25, thus providing a compressed cracked gas stream 38.

The product fractionation or separation section 40 can be configured to fractionate the compressed cracked gas stream 38, selectively hydrogenate one or more streams produced during the fractionation, and provide one or more olefin (e.g., ethylene, propylene) product streams 50. The product fractionation or separation section 40 may also provide one or more byproduct streams 60, such as, without limitation, a C₁ stream, a C₂ saturate stream, a C₃ saturate stream, a C₄ saturate stream, an acetylene stream, a butadiene stream, a l-butene stream, an isobutylene stream, an aromatics stream, a hydrogen stream, a pyrolysis gasoline stream, and/or a fuel oil stream, or streams comprising a combination of these components. Some of these streams may be recycled to one or more sections of the steam cracking plant. For example, without limitation, the C₂, C₃, and/or C₄ saturates streams may be recycled to one or more of the pyrolysis furnaces of the pyrolysis reaction section 20, hydrogen may be purified (e.g., via a pressure swing adsorption unit (PSA) and a methanation reactor to remove CO) and recycled to a hydrogenation reactor (e.g., a C₂, C₃, acetylene, or di-olefin hydrogenator) and/or utilized as a fuel source (e.g., via fuel cell). The C₁ stream may also be recycled for use as a fuel (e.g., for the production of hydrogen therefrom).

Referring now to FIG. 2, and as also noted above, pyrolysis reaction section 20 can comprise at least one steam cracker or ‘pyrolysis’ furnace 100 configured to crack hydrocarbons in the presence of steam to produce a cracked gas stream, and a quench unit 200 (e.g., a transfer line exchanger (TLE) or other heat transfer device) to quench (and optionally harvest heat from) the cracked gas stream to provide a cooled cracked stream 25. As shown in FIG. 2, the furnace generally includes a fluid inlet 104 and a fluid outlet 108, with the fluid outlet 108 in fluid communication with a fluid inlet 204 of the quench unit 200.

FIGS. 1 and 2 depict one example of a steam cracking system for illustration purposes, but the present radiative electric furnaces can be used in any of various steam cracking systems and processes.

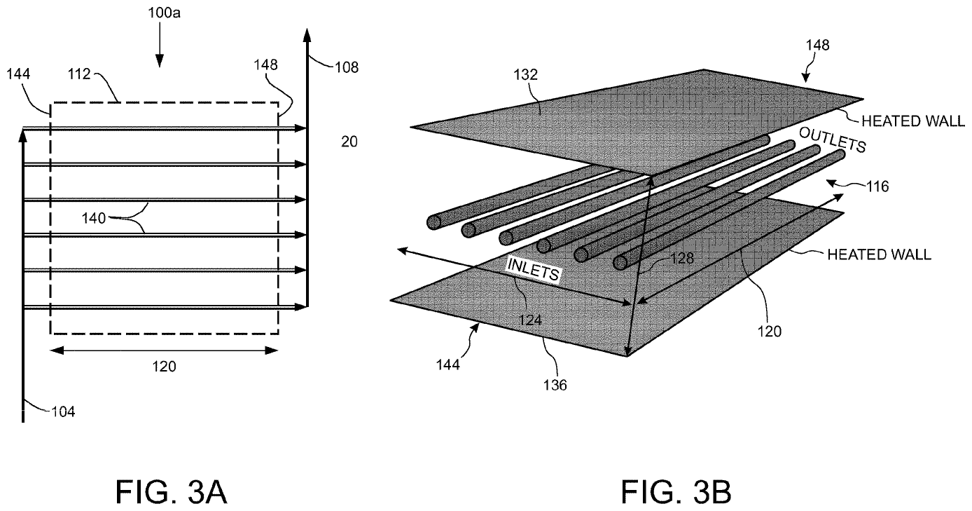

Referring now to FIGS. 3A-3B; FIG. 3A depicts a conceptual block diagram of a first example 100a of a unidirectional-flow electric furnace for use in the pyrolysis reaction section of steam cracking systems and processes (e.g., of FIG. 2); and FIG. 3B depicts a cutaway perspective view of upper and lower walls and fluid tubes of the electric furnace of FIG. 3A. As shown, furnace 100a generally includes fluid inlet 104 and a fluid outlet 108, a housing 112 defining a radiant heating chamber 116 having a length 120, a width 124, and a height 128. Furnace 100a also includes one or more first electric heating elements 132 disposed on a first side of the radiant heating chamber, and one or more second electric heating elements 136 disposed on a second side of the radiant heating chamber and spaced apart from the first electric heating element(s). The furnace also comprises a plurality of tubes 140 in fluid communication with the fluid inlet (104) and the fluid outlet (108). As shown, tubes 140 are disposed between the first and second electric heating elements 132, 136, and extend at least a majority of the length (120) of radiant heating chamber 116. In this conventional configuration, the tubes are configured such that fluid flows through all of the tubes in a first direction from a first end (or upper portion) 144 of the radiant heating chamber toward a second end (or lower portion) 148 of the chamber.

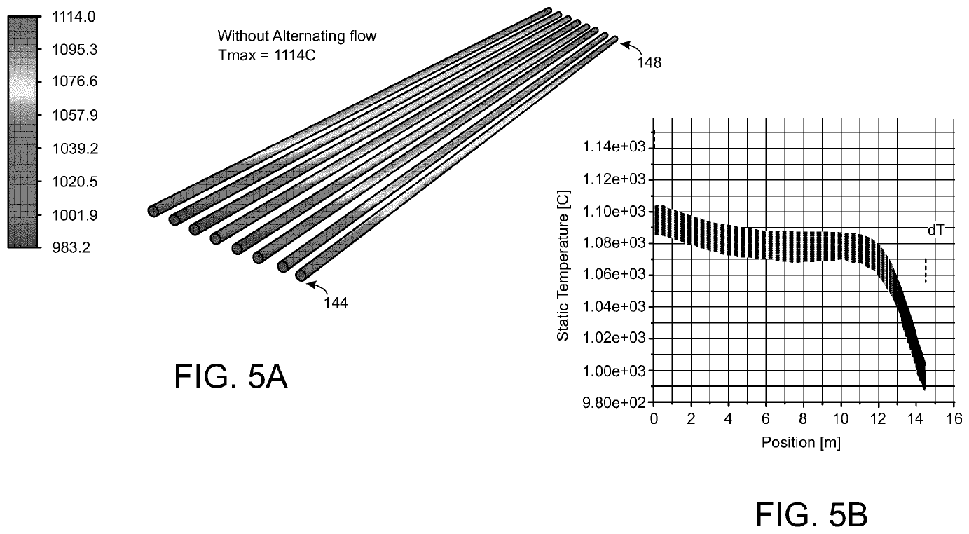

By way of example, at least some cracking furnaces heat the fluid from a first temperature (e.g., of from about 650° C. to about 750° C.) to a second temperature (e.g., of from about 850° C. to about 900° C.), at pressures of 2-5 bar, in tubes having a diameter of from about 2 inches to about 4 inches that are otherwise empty (are not packed with catalyst). Due to the combination of heating and cracking reactions, the temperature from inlet portion to outlet portion in the heater typically exhibits an “n” shaped profile that rises from the inlet portion, is relatively flat in a medial part of the tube, and sinks near the outlet portion, as shown, for example, in FIG. 5B. In such steam cracking furnaces, some or all of the tubes in the heater housing may increase (e.g., in step-wise fashion) in diameter from an inlet portion with a smaller first diameter (e.g., from about 2 inches to about 3 inches) to an outlet portion with a larger second diameter (e.g., from about 3 inches to about 4 inches).

In the configuration of FIGS. 3A-3B, the lower-temperature fluid entering the heating chamber is able to absorb more thermal energy at or near the first end 144 than the higher-temperature fluid exiting the chamber is able to absorb at or near the second end 148. As a result, the temperature of the heating elements 132, 136 is increased at the second end 148, which can be problematic for the heating elements because radiative heating element lifetime is typically shortened with time spent at or near maximum temperature. Additionally, temperature gradients between the first end 144 and the second end 148 can introduce mechanical stresses in the heater housing, such as in the housing wall to which the element is coupled.

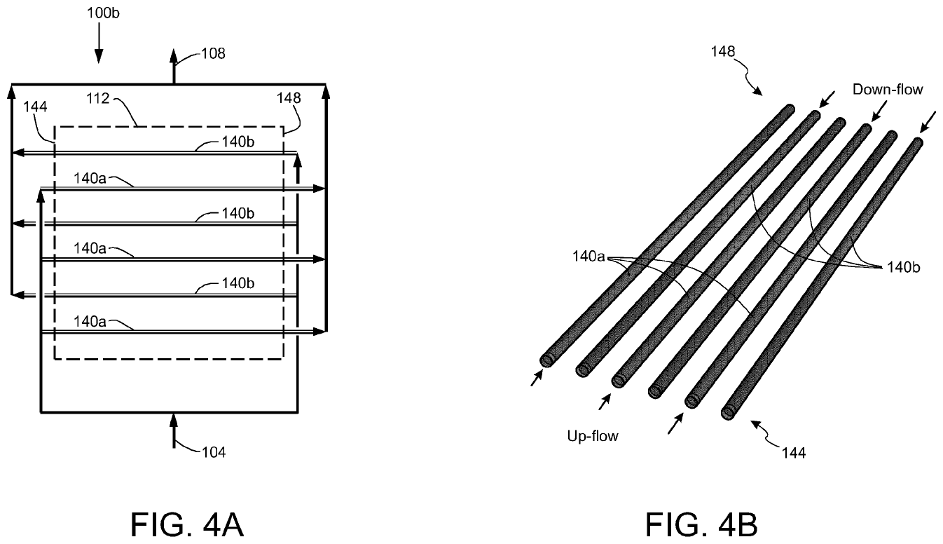

Referring now to FIGS. 4A, FIG. 4A depicts a conceptual block diagram of a first example 100b of a counter-flow electric furnace for use in the pyrolysis reaction section of steam cracking systems and processes (e.g., of FIG. 2), and FIG. 4B depicts a cutaway perspective view of fluid tubes of the electric furnace of FIG. 4A. Furnace 100b is similar to furnace 100a, with the exception that furnace 100b is configured to direct a first part of the fluid in a first direction through the heating chamber, and a second part of the fluid in a second direction through the heating chamber. More specifically, furnace 100b is configured (e.g., via manifold) to direct a first part of the fluid from inlet 104 to a plurality of first tubes 140a, and a second part of the fluid from inlet 104 to a plurality of second tubes 140b. First tubes 140a are configured to carry fluid in a first direction from first end (or upper portion) 144 of the radiant heating chamber toward second end (or lower portion) 148 of the radiant heating chamber, and second tubes 140b are configured to carry fluid in a second direction from second end (or lower portion) 148 of the radiant heating chamber toward first end (or upper portion) 144 of the radiant heating chamber. In this configuration, the first and second tubes 140a, 140b are alternated (140a, 140b, 140a, 140b, 140a, 140b) along the width 128 of the heating chamber. As shown, tubes 140b are parallel to each other and to tubes 140a, such that the second direction is parallel and opposite to the first direction.

In this configuration, the lower-temperature ends of the first tubes 140a are disposed at first end (or upper portion) 144 of the heating chamber, and the lower-temperature ends of the second tubes 140b are disposed at second end (or lower portion) 148 of the heating chamber. Thus, the lower temperature ends of the first tubes 140a help to thermally balance the higher-temperature ends of the second tubes 140b such that the lower-temperature ends of the first tubes 140a can absorb thermal energy from the heating elements at the first end 144; and the lower-temperature ends of the second tubes 140b help to thermally balance the higher-temperature ends of the first tubes 140a such that the lower-temperature ends of the second tubes 140b can absorb thermal energy from the heating elements at the second end 148. As a result, the temperature of the heating elements 132, 136 is approximately equivalent at the first end 144 and the second end 148, lowering the maximum temperature (and increasing useful life) of the heating elements and reducing the temperature gradient (and resulting mechanical stresses) across each heating element.

Referring now to FIGS. 5A-5B; FIG. 5A depicts a perspective view of fluid tubes of a second example 100c of a unidirectional-flow electric furnace for use in the pyrolysis reaction section of steam cracking systems and processes (e.g., of FIG. 2); and FIG. 5B depicts a chart of temperature profile of the fluid tubes of FIG. 5A. Furnace 100c is similar to furnace 100a, with the exception that furnace 100c includes eight (8) tubes instead of six (6) tubes, and is configured to operate under different temperature conditions. The depicted configuration was modeled for ethane cracking at an inlet temperature of 692° C., flow rate of 0.033 kilograms per second (kg/s), C₂H₆ mass fraction of 0.714 and steam H₂O mass fraction of 0.286, and a pressure of 2 bar using a Reaction Channel model in Fluent. The modeled tubes each had an internal diameter of 50.8 millimeters (mm), a length of 14.5 meters (m) within the furnace, and a wall thickness of 3.5 mm. Radiative heaters were modeled on opposing walls (as in FIG. 3B), each with a surface area of 23.6 m2 and a thermal power input of 0.098 Megawatts (MW) per tube. In this configuration, modeling revealed—for the eight-tube, unidirectional-flow configuration—a tube temperature variation (Tₘₐₓ−Tₘᵢₙ) of about 19° C., and a maximum tube temperature of about 1,114° C. (maximum circumferential average of about 1,095° C.) and, for the heaters (or heated walls) themselves, a maximum temperature of about 1,211° C. and average temperature of about 1,189° C.

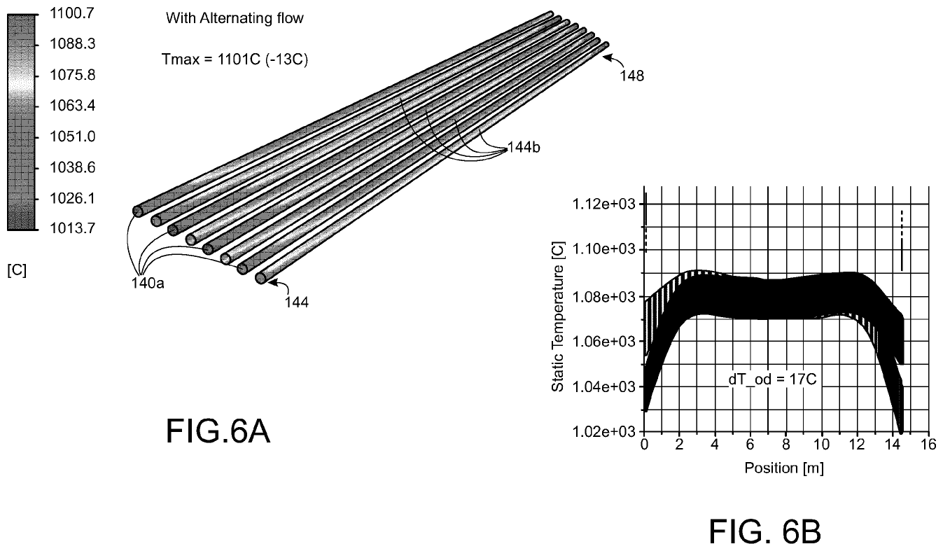

Referring now to FIGS. 6A-6B; FIG. 6A depicts a perspective view of fluid tubes of a second example 100d of a counter-flow electric furnace for use in the pyrolysis reaction section of steam cracking systems and processes (e.g., of FIG. 2); and FIG. 6B depicts a chart of temperature profile of the fluid tubes of FIG. 6A. Furnace 100d is similar to furnace 100c, with the exception that furnace 100d is configured to direct a first part of the fluid in a first direction through the heating chamber, and a second part of the fluid in a second direction through the heating chamber. More specifically, furnace 100d is configured (e.g., via manifold) to direct a first part of the fluid from inlet 104 to a plurality of first tubes 140a, and a second part of the fluid from inlet 104 to a plurality of second tubes 140b. First tubes 140a are configured to carry fluid in a first direction from first end 144 of the radiant heating chamber toward second end 148 of the radiant heating chamber, and second tubes 140b are configured to carry fluid in a second direction from second end 148 of the radiant heating chamber toward first end 144 of the radiant heating chamber. In this configuration, the first and second tubes 140a, 140b are alternated (140a, 140b, 140a, 140b, 140a, 140b, 140a, 140b) along the width of the heating chamber. As shown, tubes 140b are parallel to each other and to tubes 140a, such that the second direction is parallel and opposite to the first direction. In some configurations, from 35% to 65%, or from 40% to 60% or from 45% to 55% of a total number of tubes (which is equal to a total number of first tubes plus a total number of second tubes) are first tubes

As described above for furnace 100b, in this configuration of furnace 100d, the lower-temperature ends of the first tubes 140a are disposed at first end (or upper portion) 144 of the heating chamber, and the lower-temperature ends of the second tubes 140b are disposed at second end (or lower portion) 148 of the heating chamber. Thus, the lower temperature ends of the first tubes 140a help to thermally balance the higher-temperature ends of the second tubes 140b such that the lower-temperature ends of the first tubes 140a can absorb thermal energy from the heating elements at the first end 144; and the lower-temperature ends of the second tubes 140b help to thermally balance the higher-temperature ends of the first tubes 140a such that the lower-temperature ends of the second tubes 140b can absorb thermal energy from the heating elements at the second end 148. As a result, the temperature of the heating elements 132, 136 is approximately equivalent at or near the first end 144 and at or near the second end 148, lowering the maximum temperature (and increasing useful life) of the heating elements and reducing the temperature gradient (and resulting mechanical stresses) across each heating element. This counter-flow configuration was modeled with the same parameters as described above for FIGS. 5A-5C. In the counter-flow configuration of FIGS. 6A-6C, modeling revealed a tube temperature variation (Tₘₐₓ−Tₘᵢₙ) of 17° C., and a maximum tube temperature of about 1,101° C. (maximum circumferential average of about 1,085° C.) and, for the heaters (or heated walls) themselves, a maximum temperature of about 1,197° C. and average temperature of about 1,190° C. As such, the counter-flow configuration reduced—relative to the unidirectional-flow configuration—the maximum temperature of the tube and, in turn, the maximum temperature of the heater, which can be expected to improve the useful life of the heater. Table 1 summarizes certain key differences between the foregoing configurations.

TABLE 1

| | Parallel Flow | 1-Row Alternating |
|---|---|---|
| ° C. | (FIG. 5A) | (FIG. 6A) |
| Max Tube Temperature | (1095) | (1085) |
| (circumferential average) | | |
| Max Heater Temperature | 1211 | 1197 |
| Average Heater Temperature | 1189 | 1190 |

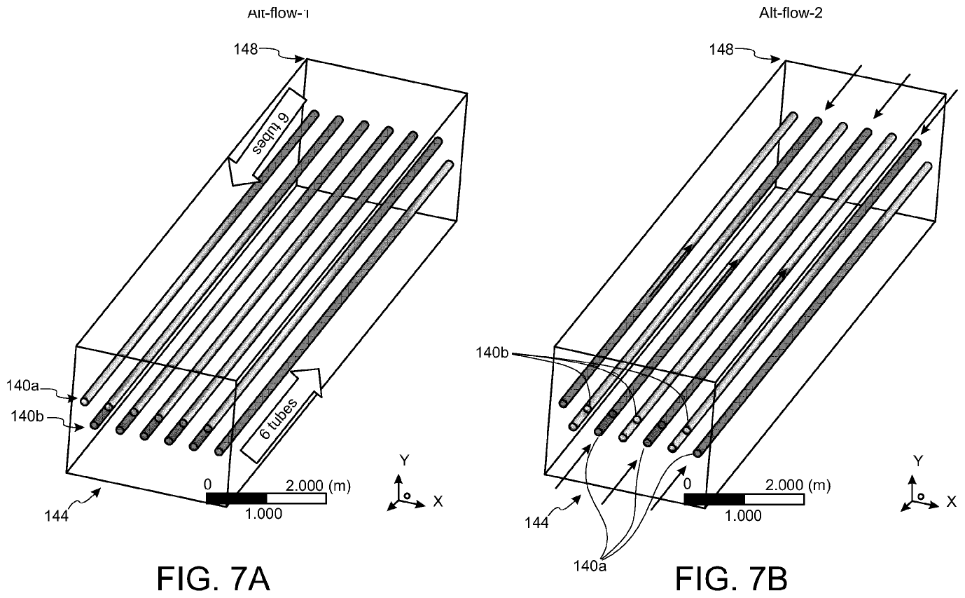

Referring now to FIGS. 7A-7B, FIGS. 7A and 7B respectively depict cutaway perspective views of third and fourth examples 100e, 100f of the present counter-flow electric furnaces for the pyrolysis section of FIG. 2. Furnaces 100e and 100f each depict dual-row configurations in which the first and second tubes 140a, 140b are arranged in two rows of tubes. In furnace 100e (FIG. 7A), all of the first tubes 140a are disposed in a first (upper) row that is closer to the first (upper) electric heating element(s), and all of the second tubes 140b are disposed in a second (lower) row between the first row and the second (lower) electric heating element(s). In contrast, in furnace 100f (FIG. 7B), the first (upper) and second (lower) rows each comprises alternating first and second tubes (140a, 140b, 140a, 140b, etc.), with the first (upper) row starting (on the left side, in the depicted orientation) with a first tube 140a, and the second (lower) row starting (on the left side, in the depicted orientation) with a second tube 140b so that in the vertical direction, each first tube 140a is paired with a second tube 140b. In this configuration, each tube of the first (upper) row is aligned vertically with a corresponding tube of the second (lower) row. In other configurations, the first (upper) row can be laterally offset (in the width direction) relative to the second (lower) row.

As described above for furnaces 100b and 100d, in these configurations of furnace 100e and 100f, the lower-temperature ends of the first tubes 140a are disposed at first end 144 of the heating chamber, and the lower-temperature ends of the second tubes 140b are disposed at second end 148 of the heating chamber. Thus, the lower temperature ends of the first tubes 140a help to thermally balance the higher-temperature ends of the second tubes 140b such that the lower-temperature ends of the first tubes 140a can absorb thermal energy from the heating elements at the first end 144; and the lower-temperature ends of the second tubes 140b help to thermally balance the higher-temperature ends of the first tubes 140a such that the lower-temperature ends of the second tubes 140b can absorb thermal energy from the heating elements at the second end 148. As a result, the temperature of the heating elements 132, 136 is approximately equivalent at the first end 144 and the second end 148, lowering the maximum temperature (and increasing useful life) of the heating elements and reducing the temperature gradient (and resulting mechanical stresses) across each heating element.

In certain implementations of the present methods of steam cracking, the method comprises: directing fluid into a fluid inlet (e.g., 104) of a furnace and through a plurality of tubes (e.g., 140) between first and second electric heating elements (e.g., 132, 136) disposed on opposing sides of a radiant heating chamber (e.g., 116) of the furnace (e.g., 100b, 100d, 100e, 100f) to heat the fluid to a reaction temperature and begin a cracking reaction, the tubes extending along a length (e.g., 120) of the heating chamber and in fluid communication with a fluid outlet (e.g., 108) of the furnace, the fluid comprising a hydrocarbon feedstock and steam. Some such implementations further comprise: directing the fluid from the fluid outlet (e.g., 108) to an inlet (e.g., 204) of a quench unit (e.g., 200) to reduce the temperature of the fluid to below the reaction temperature and slow or stop the cracking reaction. In such implementations, the plurality of tubes comprises a plurality of first tubes (e.g., 140a) and a plurality of second tubes (e.g., 140b), and directing the fluid into the plurality of tubes comprises simultaneously: directing a first portion of the fluid into the first tubes (e.g., 140a) in a first direction extending from a first end (e.g., 144) of the heating chamber toward a second end (e.g., 148) of the heating chamber; and directing a second portion of the fluid into the second tubes (e.g., 140b) in a second direction extending from a second end (e.g., 148) of the heating chamber toward the first end (e.g., 144) of the heating chamber. In some implementations, the hydrocarbon feedstock comprises naphtha, liquefied petroleum gas (LPG), and/or ethane. In some implementations of the present methods, the heating elements exhibit a maximum temperature (T_{MAX}) and an average temperature (T_{AVE}); and, as the fluid flows through the plurality of tubes, the difference between T_{MAX} and T_{AVE} (T_{MAX}−T_{AVE}) is less than one percent (1%) of T_{MAX}. In some implementations of the present methods, the first and second electric heating elements reach a maximum temperature in excess of 1000° or in excess of 1050° C. while the fluid flows through the plurality of tubes.

Additional details about various components of steam cracking plants and processes can be found in International Patent Application Publication No. WO2020/150244, which is incorporated by reference in its entirety.

The above specification and examples provide a complete description of the structure and use of exemplary embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the present devices are not intended to be limited to the particular forms disclosed. Rather, they include all modifications and alternatives falling within the scope of the claims, and embodiments other than the one shown may include some or all of the features of the depicted embodiment. For example, components may be combined as a unitary structure, and/or connections may be substituted. Further, where appropriate, aspects of any of the examples described above may be combined with aspects of any of the other examples described to form further examples having comparable or different properties and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A steam cracking system comprising:
a quench unit having a quench unit inlet;
a radiative electric furnace having an fluid inlet and a fluid outlet in fluid communication with the quench unit inlet, the furnace comprising:
a housing defining a radiant heating chamber having a length, a width, and a height;
one or more first electric heating elements disposed on a first side of the radiant heating chamber;
one or more second electric heating elements disposed on a second side of the radiant heating chamber and spaced apart from the first electric heating element(s);
a plurality of first tubes disposed between the first and second electric heating elements, and extending at least a majority of the length of the radiant heating chamber; and
a plurality of second tubes disposed between the first and second electric heating elements, and extending at least a majority of the length of the radiant heating chamber;
where the first tubes are in fluid communication with the fluid inlet and configured to carry a fluid in a first direction from a first end of the radiant heating chamber toward a second end of the radiant heating chamber; and
where the second tubes are in fluid communication with the fluid inlet and configured to carry a fluid in a second direction from a second end of the radiant heating chamber toward a first end of the radiant heating chamber.

2. The steam cracking system of claim 1, where the second direction is parallel to the first direction.

3. The steam cracking system of claim 1, where at least one of the second tubes of the furnace is disposed one of (a)-(c):
(a) between two of the first tubes;
(b) between one of the first tubes and one of the first and second electric heating elements; or
(c) both (a) and (b).

4. The steam cracking system of claim 1, where the first and second tubes are arranged in two rows of tubes, a first one of the two rows is disposed closer to the first electric heating element(s) than to the second electric heating element(s), and a second one of the two rows is disposed between the first row and the second electric heating element(s).

5. The steam cracking system of claim 4, where the first row comprises all of the first tubes, and the second row comprises all of the second tubes.

6. The steam cracking system of claim 4, where the first and second rows each comprises alternating first and second tubes.

7. The steam cracking system of claim 1, where the first and second electric heating elements are configured to reach a maximum temperature in excess of 1050° C.

8. The steam cracking system of claim 1, where the first and second tubes are also in fluid communication with the fluid outlet.

9. The steam cracking system of claim 1, further comprising a first inlet manifold between the fluid inlet and the first tubes, and a second inlet manifold between the fluid inlet and the second tubes.

10. A method of steam cracking, the method comprising:
directing fluid into a fluid inlet of a furnace and through a plurality of tubes between first and second electric heating elements disposed on opposing sides of a radiant heating chamber of the furnace to heat the fluid to a reaction temperature and begin a cracking reaction, the tubes extending along a length of the heating chamber and in fluid communication with a fluid outlet of the furnace, the fluid comprising a hydrocarbon feedstock and steam;
directing the fluid from the fluid outlet to an inlet of a quench unit to reduce the temperature of the fluid to below the reaction temperature and slow or stop the cracking reaction;
where the plurality of tubes comprises a plurality of first tubes and a plurality of second tubes, and directing the fluid into the plurality of tubes comprises simultaneously:
directing a first portion of the fluid into the first tubes in a first direction extending from a first end of the heating chamber toward a second end of the heating chamber; and
directing a second portion of the fluid in a second direction into the second tubes in a second direction extending from a second end of the heating chamber toward the first end of the heating chamber.

11. The method of claim 10, where the hydrocarbon feedstock comprises at least one component selected from the list of components consisting of: naphtha, liquefied petroleum gas (LPG), and ethane.

12. The method of claim 10, where at least one of the second tubes of the furnace is disposed one of (a)-(c):
(a) between two of the first tubes;
(b) between one of the first tubes and one of the first and second electric heating elements; or
(c) both (a) and (b).

13. The method of claim 10, where the first and second tubes are arranged in two rows of tubes, a first one of the two rows is disposed closer to the first electric heating element(s) than to the second electric heating element(s), and a second one of the two rows is disposed between the first row and the second electric heating element(s).

14. The method of claim 10, where the heating elements exhibit a maximum temperature (T_{MAX}) and an average temperature (T_{AVE}); and where, as the fluid flows through the plurality of tubes, the difference between T_{MAX} and T_{AVE} (T_{MAX}−T_{AVE}) is less than one percent (1%) of T_{MAX}.

15. The method of claim 10, where the first and second electric heating elements reach a maximum temperature in excess of 1050° C. while the fluid flows through the plurality of tubes.
